(19) United States
(12) Patent Application Publication
(10) Pub. No.: US 2026/0362468 A1
(43) Pub. Date: Nov. 12, 2026

(54) METHOD, SYSTEM, AND COMPUTER PROGRAM PRODUCT FOR NETWORK RESOURCE MANAGEMENT

(71) Applicant: Alpha Networks Inc., Hsinchu (TW)

(72) Inventors: Meng-Han WU, Hsinchu (TW); Shih-Fang AO, Hsinchu (TW); An-Cheng TSENG, Hsinchu (TW); Jih-Hsin LIU, Hsinchu (TW)

(21) Appl. No.: 19/384,048

(22) Filed: Nov. 10, 2025

(30) Foreign Application Priority Data
May 6, 2025 (TW) 114116927

(51) Int. Cl. H04W 72/543; H04L 1/00; H04W 52/36; H04W 72/20

(52) U.S. Cl. CPC H04W 72/543; H04L 1/0003; H04W 52/365; H04W 72/20

(57) ABSTRACT

A method for network resource management between a base station and multiple end user devices is provided. The base station stores multiple data rate upper limit parameters corresponding respectively to the end user devices, and multiple transmission records corresponding respectively to the end user devices. The method includes: calculating multiple quality assessment indicators corresponding respectively to the end user devices, wherein each quality assessment indicator indicates the transmission quality of the corresponding end user device within an evaluation period; ranking the end user devices, and designating those of the end user devices having the lowest rank as target end user device(s); for each target end user device, obtaining a designated rate limiting value; and controlling the base station to set, for each target end user device, the corresponding data rate upper limit parameter to be the designated rate limiting value that corresponds to the target end user device.

### CROSS-REFERENCE TO RELATED APPLICATION

This application claims priority to Taiwanese Invention patent application No. 114116927, filed on May 6, 2025, the entire disclosure of which is incorporated by reference herein.

### FIELD

The disclosure relates to a method, a system, and a computer program product for network resource management, and more particularly to a method, a system, and a computer program product for network resource management that optimizes resource block utilization through a rate-limiting mechanism for multiple users.

### BACKGROUND

In a mobile network, a base station is an important transmission node for end user devices (e.g., various network connection devices in a fifth generation (5G) smart factory) to upload or download data. In conventional technology, the total uplink bandwidth is equally distributed by the base station to the end user devices.

However, if the communication quality of some of the end user devices with the base station is poor, the transmission error rate may increase, resulting in a lower actual transmission rate for those end user devices. As a result, the base station may have a lower total throughput, leading to poor utilization of its bandwidth resources.

### SUMMARY

Therefore, an object of the disclosure is to provide a method, a system, and a computer program product for network resource management that can alleviate at least one of the drawbacks of the prior art.

According to an aspect of the disclosure, a method for network resource management is provided. The method is implemented by a management system, and is adapted to manage network resources that are needed for data transmission between a base station and a plurality of end user devices. The base station stores a network resource management dataset and a log dataset. The network resource management dataset includes a plurality of data rate upper limit parameters, each of which corresponds to a respective one of the end user devices and is used for limiting a maximum rate for transmission between that end user device and the base station. The log dataset includes a plurality of transmission records, each of which corresponds to a respective one of the end user devices and indicates a variation in transmission quality of that end user device. The method includes steps of: A) calculating, based on the plurality of transmission records, a plurality of quality assessment indicators that correspond respectively to the end user devices, wherein each of the plurality of quality assessment indicators indicates the transmission quality of the corresponding one of the end user devices within an evaluation period; B) ranking the end user devices based on the quality assessment indicators, and designating at least one of the end user devices having the lowest rank as at least one target end user device; C) for each of the target end user devices, obtaining a designated rate limiting value that corresponds to the target end user devices based on the corresponding transmission record; and D) controlling the base station to set, for each of the target end user devices, the corresponding data rate upper limit parameter to be the designated rate limiting value that corresponds to the target end user device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a management system according to an embodiment of the disclosure.

FIG. 2 is a flow chart illustrating a method for network resource management according to an embodiment of the disclosure.

FIG. 3 is a flow chart illustrating sub-steps of performing a grouping procedure of the method.

FIG. 4 is a flow chart illustrating sub-steps of performing a rate-limiting procedure of the method.

FIG. 5 is a flow chart illustrating sub-steps of performing a rate limiting value adjustment procedure for the first time.

FIG. 6 is a flow chart illustrating sub-steps of performing the rate limiting value adjustment procedure for the second time.

FIG. 7 is a flow chart illustrating sub-steps of performing a signal variation observation procedure of the method.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “connected to” may refer to a direct connection among a plurality of pieces of electrical apparatus/devices/equipment via an electrically conductive material (e.g., an electrical wire, a semi-conductive material), or an indirect connection between two pieces of electrical apparatus/devices/equipment via another one or more pieces of apparatus/devices/equipment, or wireless communication (e.g., Wi-Fi, Bluetooth®, electromagnetic conduction).

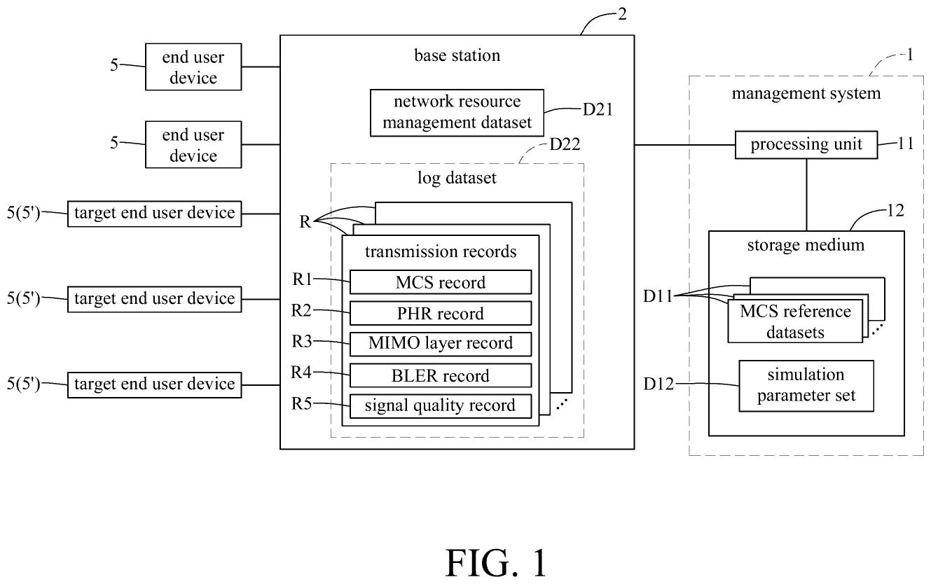

Referring to FIG. 1, according to an embodiment of the disclosure, the management system 1 is adapted to manage network resources that are needed for data transmission between a base station 2 and a plurality of end user devices 5 (five end user devices 5 are exemplified in FIG. 1).

In this embodiment, “transmission” between the base station 2 and each of the end user devices 5 refers to the “uplink transmission” of each of the end user devices 5 (i.e., the transmission of data from each of the end user devices 5 to the base station 2). However, in other embodiments, the present disclosure may also be used to manage the network resources that are needed for “downlink transmission” (i.e., the transmission of data downloaded by each of the end user devices 5 from the base station 2).

Each of the end user devices 5 may be a network connection device in a fifth generation (5G) smart factory, such as a computer, a server, a mobile electronic device, etc.

In this embodiment, the base station 2 complies with the 5G New Radio (NR) wireless communication standard of the 5G mobile communication network, and may be referred to as a Next-Generation Node B (gNB).

The base station 2 stores a network resource management dataset D21 and a log dataset D22.

The network resource management dataset D21 includes a device quantity indicating a total number of the end user devices 5, a plurality of data rate upper limit parameters that correspond respectively to the end user devices 5, a resource block (RB) total quantity parameter, uplink-downlink configuration data, and modulation and coding scheme (MCS) data.

In this embodiment, each of the data rate upper limit parameters is a user equipment aggregate maximum bit rate (UE-AMBR) parameter, which is used for limiting a maximum rate for uplink transmission between the corresponding end user device 5 and the base station 2.

In this embodiment, the RB total quantity parameter is a number of physical resource blocks (Nprb) parameter, which indicates a total number of RBs provided by the base station 2 (e.g., 270 RBs).

The uplink-downlink configuration data refers to the time division duplex uplink/downlink configuration data, which indicates a ratio of an uplink bandwidth portion to a downlink bandwidth portion in a total bandwidth provided by the base station 2. In one example, the uplink-downlink configuration data may indicate that the uplink bandwidth portion occupies 40% of the total bandwidth, and the downlink bandwidth portion occupies 60% of the total bandwidth.

The MCS data includes an MCS table that is used by the base station 2. In this embodiment, the MCS table is exemplified as shown in Table 5.1.3.1-1 of TS38.214 that is published by the 3rd Generation Partnership Project (3GPP), where TS38.214 refers to a publicly available technical document published by 3GPP, titled “Technical Specification for Physical layer procedures for data”.

The log dataset D22 includes a plurality of transmission records R that correspond respectively to the end user devices 5. Each transmission record R includes a plurality of transmission quality reference values, such as an MCS record R1, a power headroom report (PHR) record R2, an multi-input multi-output (MIMO) layer record R3, a block error rate (BLER) record R4, and a signal quality record R5, thereby indicating a variation in the uplink transmission quality of the corresponding end user device 5 over time.

The MCS record R1 includes a plurality of clusters of MCS indexes corresponding to a plurality of historical periods, where the historical periods are consecutive and have equal time lengths (e.g., each historical period is five minutes long). Each of the clusters of MCS indexes includes a plurality of MCS indexes recorded during the corresponding historical period, and indicates a variation in the MCS of the corresponding end user device 5 during that period, which represents changes in signal quality. In this embodiment, the scheme may involve quadrature phase shift keying (QPSK) modulation or 64-quadrature amplitude modulation (64-QAM).

The PHR record R2 includes a plurality of average PHRs that correspond respectively to the historical periods. Each of the average PHRs indicates a spare state of a transmission power of the corresponding one of the end user devices 5 during the corresponding historical period for uplink transmission. Specifically, when the average PHR has a positive value, the average PHR indicates that the spare state of the transmission power is sufficient. Otherwise, when the average PHR has a negative value, the average PHR indicates that the spare state of the transmission power is insufficient.

The MIMO layer record R3 includes a plurality of average MIMO layer values that correspond respectively to the historical periods. In this embodiment, the base station 2 is configured to adjust, for each of the end user devices 5, MIMO layer values according to the MCS indexes in real time. In one example, for each of the MCS indexes of the end user device 5, when a value of that MCS index is equal to 9 or below, the MIMO layer value is set to 1, and when the value of that MCS index of the end user device 5 is equal to 10 or above, the MIMO layer value is set to 2.

The BLER record R4 includes a plurality of BLER average values that correspond respectively to the historical periods. Each of BLER average values indicates a BLER of the blocks received by the base station 2 from the corresponding end user device 5 during the corresponding historical period. In this embodiment, the base station 2 is configured to, for each of the end user devices 5, dynamically adjust the MCS index of the end user device 5 based on the BLER of the end user device 5. Specifically, for each end user device 5, the base station 2 is configured to determine whether the BLER is less than an error rate lower limit value (e.g., 1%), and to determine whether the BLER is greater than an error rate upper limit value (e.g., 2%). When it is determined that the BLER is less than the error rate lower limit value, the base station 2 adjusts the MCS index of the end user device 5 to increase (e.g., increased by 1). When it is determined that the BLER is greater than the error rate upper limit value, the base station 2 adjusts the MCS index of the end user device 5 to decrease (e.g., decreased by 1). When it is determined that the BLER is neither less than the error rate lower limit value nor greater than the error rate upper limit value, the MCS index of the end user device 5 is unchanged.

The signal quality record R5 includes a plurality of signal quality parameters that correspond respectively to the historical periods. In this embodiment, each of the signal quality parameters is an average value of the received signal strength indication (RSSI), which is used to indicate a quality of an uplink signal received by the base station 2 from the corresponding end user device 5 during the corresponding historical period. In other embodiments, each of the signal quality parameters may be an average value of the signal to interference plus noise ratio (SINR).

Further, the base station 2, for each of the end user devices 5, periodically updates the transmission record R based on the data transmission status between the base station 2 and that end user device 5. Specifically, the base station 2 updates the transmission record R by obtaining the cluster of MCS indexes, the average PHR, the average MIMO layer value, the BLER average value and the signal quality parameter that correspond to the most recent historical period (i.e., the latest historical period) and writing them respectively into the MCS record R1, the PHR record R2, the MIMO layer record R3, the BLER record R4, and the signal quality record R5. The method for updating each transmission record R by the base station 2 in the field of 5G NR wireless communication standards is known to one skilled in the art, and will not be described in further detail for the sake of brevity.

In this embodiment, the management system 1 is a computer that includes a processing unit 11, and a storage medium 12 that is electrically connected to the processing unit 11. The processing unit 11 is a processor implemented by an integrated circuit that has data calculation and instruction transmission/reception functions. In other embodiments, the processing unit 11 may be a circuit component that includes a processor and a circuit board, or a collection of multiple processors. The storage medium 12 is a digital data storage device (e.g., a hard disk drive) used for storing digital data. In other embodiments, the storage medium 12 may be a collection of multiple storage devices of the same or different types, such as read only memory (ROM), programmable ROM (PROM), or flash memory.

In other embodiments, the management system 1 may be implemented as a plurality of servers that are electrically connected to each other. In such a case, the processing unit 11 may be implemented as a collection of multiple processors/circuit components respectively included in the servers, and the storage medium 12 may be implemented as a collection of multiple storage mediums respectively included in the servers.

The storage medium 12 stores a plurality of MCS reference datasets D11 and a simulation parameter set D12, and stores instructions that are to be executed by the processing unit 11 for performing the method.

Each of the MCS reference datasets D11 includes an MCS reference table, a range configuration rule, and a weight configuration rule. The range configuration rule indicates multiple MCS ranges (e.g., from 0 to 4 (0≤MCS≤4), from greater than 4 up to 9 (4<MCS≤9), from greater than 9 up to 16 (9<MCS≤16), and from greater than 16 up to 28 (16<MCS≤28)) of the MCS reference table. The weight configuration rule indicates multiple MCS weighted values (e.g., “0”, “2”, “4”, and “6”) that correspond respectively to the MCS ranges.

The simulation parameter set D12 indicates a plurality of transmission settings respectively set for the end user devices 5 by the base station 2 under a default worst signal condition. In one example, the simulation parameter set D12 includes a simulated MIMO layer value, a simulated subcarrier spacing, a simulated number of scheduled orthogonal frequency division multiplexing (OFDM) symbols, a simulated number of demodulation reference signal (DM-RS) resource elements per physical resource block, and a simulated number of overheads configured by higher layer.

The simulated MIMO layer value may be denoted as “v (j) layers”, with a value of, for example, one, indicating that only single-layer transmission is used (i.e., MIMO transmission is not employed). The simulated subcarrier spacing may be denoted as “u”, with a value of, for example, 30 KHz, indicating that the subcarrier spacing of OFDM is 30 KHz. The simulated number of scheduled OFDM symbols may be denoted as “N sh symb”, with a value of, for example, 13, indicating that there are 13 valid OFDM symbols in a slot. The simulated number of DM-RS resource elements per physical resource block may be denoted as “N prb dmrs”, with a value of, for example, 24, indicating that 24 DM-RS resource elements are allocated to each physical resource block. The simulated number of overheads configured by higher layer may be denoted as “N prb oh”, with a value of, for example, 12, indicating that 12 resource elements are reserved for higher-layer signaling in each physical resource block.

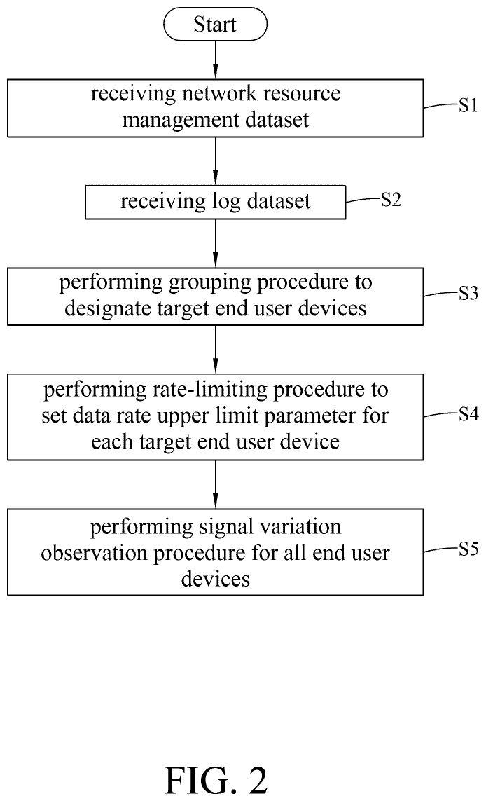

Referring to FIGS. 1 and 2, according to the embodiment of the disclosure, the management system 1 implements a method for network resource management for multiple users, where the method includes steps S1 to S5.

Before describing the method in further detail, it should be noted that, in order for each of the transmission records R to accurately reflect changes in the transmission quality of the corresponding end user device 5, during the implementation of the method for network resource management by the management system 1, each of those of the end user devices 5 that is not rate-limited is configured to continuously transmit data to the base station 2 at the maximum transmission rate indicated by the corresponding data rate upper limit parameter.

In step S1, the processing unit 11 receives the network resource management dataset D21 from the base station 2, and obtains the device quantity, the data rate upper limit parameters, the RB total quantity parameter, and the uplink-downlink configuration data from the network resource management dataset D21.

In step S2, the processing unit 11 receives the log dataset D22 from the base station 2, and obtains the transmission records R from the log dataset D22.

In step S3, the processing unit 11 performs a grouping procedure on the end user devices 5 based on the network resource management dataset D21 and the log dataset D22.

In the grouping procedure, the processing unit 11 calculates, for each of the end user devices 5, a quality assessment indicator based on the corresponding transmission record R, ranks the end user devices 5 based on the quality assessment indicators respectively of the end user devices 5, and designates a specific number (at least one) of the end user devices 5 having the lowest rank as target end user devices 5′. In this embodiment, the specific number is an integer that is greater than zero and that is less than the total number of the end user devices 5. The specific number may be a fixed preset value or may be, for example, two-thirds or half of the total number of the end user devices 5, rounded up to an integer. Each of the quality assessment indicators indicates the transmission quality of the corresponding end user device 5 within an evaluation period. The evaluation period is, for example, the latest historical period among all historical periods indicated by the transmission records R.

The target end user devices 5′ are those of the end user devices 5 with poor transmission quality during the evaluation period. In this embodiment, as exemplified in FIG. 1, the processing unit 11 designates three of the end user devices 5 as the target end user devices 5′. In other embodiments, the processing unit 11 first obtains the specific number of end user devices 5 with the lowest ranking, and then designates from among the specific number of end user devices 5 those of the end user devices 5 that have the spare state of the transmission power being insufficient as the target end user devices 5′.

It should be noted that if all of the end user devices 5 have sufficient spare state of the transmission power, then none of the end user devices 5 would be designated as the target end user device 5′ in step S3. That is to say, the base station 2 and the end user devices 5 do not need to perform the method for network resource management, and the grouping procedure ends (not shown in FIG. 2).

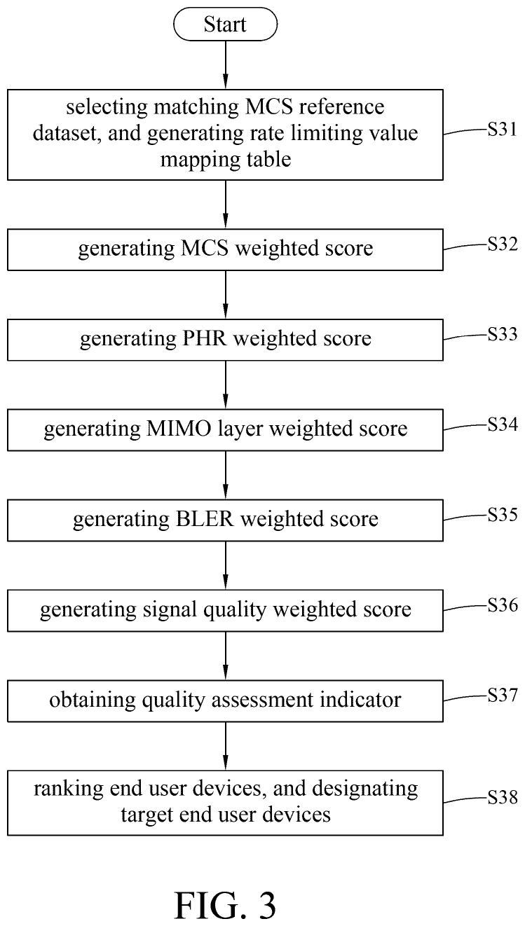

Referring further to FIG. 3, the grouping procedure (step S3) includes sub-steps S31 to S38.

In sub-step S31, the processing unit 11 selects one of the MCS reference datasets D11 that matches the MCS data of the network resource management data D21, and defines that one as a matching MCS reference dataset. Then, the processing unit 11 generates a rate limiting value mapping table based on the matching MCS reference dataset, other parameters in the network resource management dataset D21 (such as the device quantity, the data rate upper limit parameters, the RB total quantity parameter and the uplink-downlink configuration data) and the simulation parameter set D12, and stores the rate limiting value mapping table in the storage unit 12.

As shown in Table 1, the rate limiting value mapping table includes a plurality of MCS ranges of the matching MCS reference dataset arranged in vertical columns, a plurality of theoretical maximum throughputs respectively corresponding to the MCS ranges, a plurality of theoretical minimum throughputs respectively corresponding to the MCS ranges, and a plurality of MCS weighted values of the matching MCS reference dataset.

TABLE 1

| | Theoretical | Theoretical | |
|---|---|---|---|
| | Maximum | Minimum | MCS |
| | Throughputs | Throughputs | Weighted |
| MCS Ranges | (Mbps) | (Mbps) | Values |
| 28 ≥ MCS > 16 | 57.7 | 26.9 | 6 |
| 16 ≥ MCS > 9 | 26.9 | 6.9 | 4 |
| 9 ≥ MCS > 4 | 6.9 | 3.1 | 2 |
| 4 ≥ MCS ≥ 0 | 3.1 | 1.2 | 0 |

Methods for the processing unit 11 calculating the theoretical maximum throughputs and the theoretical minimum throughputs are known to one skilled in the art, and details of the calculations may be found in section 5.1.3.2 (“Transport block size determination”) of TS38.214, or may alternatively be found by referencing the 5G NR TBS (transport block size) Calculator tool on the 5G Tools for RF Wireless website (https://5g-tools.com/5g-nr-tbs-transport-block-size-calculator/). In one example, each theoretical minimum throughput is calculated by the processing unit 11 based on the lower limit or exclusive lower bound of the corresponding MCS range (e.g., 0, 4, 9, 16 in Table 1), the device quantity, the RB total quantity parameter, and the uplink-downlink configuration data and the simulation parameter set D12.

Using the theoretical minimum throughput (1.2 Mbps) that corresponds to the MCS range of “4≥MCS≥0” in Table 1 as an example, the processing unit 11 calculates the theoretical minimum throughput by first calculating a theoretical total throughput (e.g., 15.12 Mbps) based on the RB total quantity parameter (e.g., 270) and the simulation parameter set D12. Then, the processing unit 11 multiplies the theoretical total throughput by the uplink bandwidth portion (e.g., 40% of the total bandwidth) based on the uplink-downlink configuration data, so as to obtain an uplink total throughput (e.g., 6.048 Mbps). Next, the processing unit 11 divides the uplink total throughput by the device quantity (i.e., the total number of the end user devices 5, for example, five) to obtain the theoretical minimum throughput of “1.2 Mbps” (rounded down to one decimal place). Based on the above description, it is noted that the theoretical minimum throughput is inversely proportional to the total number of the end user devices 5. It should be further noted that the theoretical minimum throughput of “1.2 Mbps” indicates that when the MCS indexes respectively of the end user devices 5 are all equal to 0 (i.e., being equal to the lower limit of the MCS range of “4≥MCS≥0”), the base station 2 may still allocate a minimum bandwidth of 1.2 Mbps to each end user device 5 for uplink transmission under the default worst signal condition (i.e., when operating according to the simulation parameter set D12).

In sub-step S32, the processing unit 11 generates, for each of the end user devices 5, an MCS weighted score based on the MCS record R1 of the corresponding transmission record R.

In this embodiment, for each of the end user devices 5, the processing unit 11 generates the MCS weighted score by first calculating an average value of the cluster of MCS indexes that corresponds to the evaluation period based on the MCS record R1, so as to obtain an MCS average value within the evaluation period (e.g., the MCS average value is equal to “9.2”). Then, the processing unit 11 identifies one of the MCS ranges in the rate limiting value mapping table that covers the MCS average value as a matching MCS range (e.g., the MCS range of “16≥MCS≥9” in Table 1), and uses the MCS weighted value that corresponds to the matching MCS range (e.g., “4” in Table 1) as the MCS weighted score. In other embodiments, the MCS average value within the evaluation period is calculated in advance by the base station 2 and recorded in the MCS record R1 for direct reading.

In sub-step S33, the processing unit 11 generates, for each of the end user devices 5, a PHR weighted score based on the PHR record R2 of the corresponding transmission record R.

In this embodiment, for each of the end user devices 5, when the average PHR that corresponds to the evaluation period in the PHR record R2 is a positive value, the processing unit 11 generates a PHR weighted score indicating that the headroom state is sufficient (e.g., the PHR weighted score is a positive number). Otherwise, when the average PHR is a negative value, the processing unit 11 generates the PHR weighted score indicating that the headroom state is insufficient (e.g., the PHR weighted score is a negative number, zero, or a positive number with a very small value, representing a very low score).

In sub-step S34, the processing unit 11 generates, for each of the end user devices 5, a MIMO layer weighted score based on the MIMO layer record R3 of the corresponding transmission record R.

In this embodiment, for each of the end user devices 5, the processing unit 11 generates the MIMO layer weighted score by reading the average MIMO layer value that corresponds to the evaluation period from the MIMO layer record R3, identifying and designating as a matching MIMO layer range one of a plurality of MIMO layer ranges that are pre-stored in the storage medium 12 and that covers the average MIMO layer value, and using a MIMO weighted value that corresponds to the matching MIMO layer range and that is pre-stored in the storage medium 12 as the MIMO layer weighted score for the corresponding end user device 5.

In sub-step S35, the processing unit 11 generates, for each of the end user devices 5, a BLER weighted score based on the BLER record R4 of the corresponding transmission record R.

In this embodiment, for each of the end user devices 5, the processing unit 11 generates the BLER weighted score by reading the BLER average value that corresponds to the evaluation period from the BLER record R4, identifying as a matching BLER range one of a plurality of BLER ranges that are pre-stored in the storage medium 12 and that covers the BLER average value, and designating as the BLER weighted score a BLER weighted value that corresponds to the matching BLER range among others that are pre-stored in the storage medium 12.

In sub-step S36, the processing unit 11 generates, for each of the end user devices 5, a signal quality weighted score based on the signal quality record R5 of the corresponding transmission record R.

In this embodiment, for each of the end user devices 5, the processing unit 11 generates the signal quality weighted score by reading the signal quality parameter that corresponds to the evaluation period from the signal quality record R5, identifying as a matching signal quality range one of a plurality of signal quality ranges that are pre-stored in the storage medium 12 and that covers the signal quality parameter, and designating as the signal quality weighted score a signal quality weighted value that corresponds to the matching signal quality range among others that are pre-stored in the storage medium 12.

In sub-step S37, for each of the end user devices 5, the processing unit 11 obtains a sum of the MCS weighted score, the PHR weighted score, the MIMO layer weighted score, the BLER weighted score and the signal quality weighted score that correspond to the end user device 5, and makes the sum serve as the quality assessment indicator of the end user device 5. In other words, the processing unit 11 calculates a weighted sum of the transmission quality reference values included in the transmission record R that correspond to the evaluation period to obtain a value of the quality assessment indicator for the end user device 5.

In sub-step S38, the processing unit 11 ranks the end user devices 5 based on the quality assessment indicators from the highest value to the lowest value, and designates the specific number (e.g., 3) of the end user devices 5 that have the lowest ranking as the target end user devices 5′. In this embodiment, the processing unit 11 designates at most two-thirds of the total number of the end user devices 5 as the target end user devices 5′, but the disclosure is not limited to such. In other embodiments, the processing unit 11 designates the target end user devices 5′ based on the average PHRs corresponding to each end user device 5. That is to say, among the end user devices 5 that have the lowest ranking, only those of the end user devices 5 with the spare state of the transmission power being insufficient (i.e., the average PHR that corresponds to the evaluation period is negative) are designated as the target end user devices 5′.

The grouping procedure ends after the processing unit 11 designates the target end user devices 5′, and the flow of the method proceeds to step S4.

Referring further to FIGS. 1, 2 and 4, in step S4, the processing unit 11 performs a rate-limiting procedure on the target end user devices 5′, which includes sub-steps S41 to S48.

By performing the rate-limiting procedure, the processing unit 11 obtains a designated rate limiting value for each of the target end user devices 5′, and controls the base station 2 (e.g., through a 5G core network, not shown) to set the data rate upper limit parameter to be the designated rate limiting value of the target end user device 5′. As such, the processing unit 11 may limit the maximum transmission rate of data transmission between each target end user device 5′ and the base station 2, which not only may improve the transmission quality of each target end user device 5′ but also reduces the network resources occupied by the target end user devices 5′, thereby increasing the availability of the network resources to be utilized by other end user devices 5 (i.e., those of the end user devices 5 that are not designated as the target end user devices 5′) for better transmission quality. The rate-limiting procedure will be described in the following in detail.

In sub-step S41, the processing unit 11 generates, for each of the target end user devices 5′, an initial designated rate limiting value based on a preset worst signal condition. In this embodiment, the processing unit 11 defines a smallest theoretical minimum throughput in the rate limiting value mapping table as the initial designated rate limiting value, (e.g., defines the theoretical minimum throughput (1.2 Mbps) that corresponds to the MCS range of “4≥MCS≥0” in Table 1 as the initial designated rate limiting value). As such, the initial designated rate limiting value is equivalent to a minimum uplink bandwidth that can be allocated by the base station 2 to each end user device 5 when operating according to the simulation parameter set D12 under the preset worst signal condition.

In sub-step S42, for each of the target end user devices 5′, the processing unit 11 controls the base station 2 through the 5G core network to set the data rate upper limit parameter of the target end user device 5′ to be the corresponding initial designated rate limiting value. In other words, a transmission speed of each target end user device 5′ is changed, during the evaluation period, from an original speed (e.g., 9.6 Mbps) to 1.2 Mbps.

When the transmission rate is reduced, the number of RBs (provided by the base station 2) allocated to each target end user device 5′ is smaller than the number allocated when the transmission rate is not reduced. Therefore, the target end user device 5′ may process each RB with a relatively higher transmission power, which means that the overall transmission power can be concentrated on these smaller number of RBs. As a result, the transmission quality of the target end user device 5′ may be improved, and the BLER of the RBs may be decreased, thereby increasing the chance for the base station 2 to upgrade the MCS index of the target end user device 5′.

In sub-step S43, for each of the target end user device 5′, the processing unit 11 obtains the transmission record R that corresponds to the target end user device 5′ from the log dataset D22 stored in the base station 2, and reads the transmission quality reference value that corresponds to a first test period. The first test period is a period occurring after the evaluation period and after the data rate upper limit parameter of the target end user device 5′ is set to be the initial designated rate limiting value. For simplicity, in the following description, the rate-limiting procedure is described for only one of the target end user devices 5′.

In sub-step S44, the processing unit 11 determines whether the transmission quality of the target end user device 5′ has improved based on the transmission quality reference values that correspond respectively to the evaluation period and the first test period in the corresponding transmission record R of the log dataset D22.

In this embodiment, the processing unit 11 determines whether the transmission quality of the target end user device 5′ has improved by determining, based on the MCS record R1, the PHR record R2 and the signal quality record R5 of the corresponding transmission record R, whether the transmission quality of the target end user device 5′ during an observed historical period (in sub-step S44, the observed historical period refers to the first test period), as compared with the transmission quality of the target end user device 5′ during the evaluation period, satisfies an improvement condition. The improvement condition includes a first improvement sub-condition, a second improvement sub-condition, and a third improvement sub-condition. Only when the first, second, and third improvement sub-conditions are all met will the processing unit 11 determine that the improvement condition is met, and that the transmission quality of the target end user device 5′ has improved. The first improvement sub-condition is that the MCS average value corresponding to the observed historical period increases by an amount greater than an MCS improvement threshold value compared to the MCS average value corresponding to the evaluation period. In one example, the MCS improvement threshold value is equal to 4, but the disclosure is not limited to such. The second improvement sub-condition is that, in the PHR record R2, the average PHR that corresponds to the observed historical period is greater than or equal to the average PHR that corresponds to the evaluation period. The third improvement sub-condition is that, in the signal quality record R5, the signal quality parameter that corresponds to the observed historical period is greater than the signal quality parameter that corresponds to the evaluation period. In other embodiments, the improvement condition may include only one or two of the above three improvement sub-conditions; for example, only the first improvement is included in the improvement condition.

When the processing unit 11 determines that the transmission quality of the target end user device 5′ has been improved, it means that limiting the maximum transmission rate of the target end user device 5′ is helpful for improving the transmission quality. In this case, the rate-limiting procedure proceeds to sub-step S45 to seek a preferred rate limiting value with fast transmission rate while maintaining the transmission quality. When the processing unit 11 determines that the transmission quality of the target end user device 5′ has not been improved, the rate-limiting procedure proceeds to sub-step S49.

In sub-step S45, the processing unit 11 performs a rate limiting value adjustment procedure on the target end user device 5′, so as to set the data rate upper limit parameter to be greater than the initial designated rate limiting value. In one example, after changing the transmission speed from 9.6 Mbps to 1.2 Mbps during the evaluation period, the processing unit 11 further changes the transmission speed to increase from 1.2 Mbps to 6.9 Mbps. The processing unit 11 further defines a rate limiting adjustable range that corresponds to the target end user device 5′. Specifically, the rate limiting adjustable range is used by the processing unit 11 for determining, in sub-step S46, whether to perform the next rate limiting value adjustment procedure on the target end user device 5′.

To describe in further detail, the processing unit 11 defines the rate limiting adjustable range by designating, as a lower limit value of the rate limiting adjustable range, the maximum designated rate limiting value that improves the transmission quality of the target end user device 5′, and designating, as an upper limit value of the rate limiting adjustable range, the minimum designated rate limiting value that does not improve the transmission quality of the target end user device 5′. Specifically, the processing unit 11 uses the improvement condition to determine whether each designated rate limiting value is able to improve the transmission quality of the target end user device 5′.

In one example, before executing the rate limiting value adjustment procedure for the target end user device 5′ for the first time, since the processing unit 11 has determined in sub-step S44 that the initial designated rate limiting value (1.2 Mbps) is able to improve the transmission quality of the target end user device 5′, the processing unit 11 temporarily sets “1.2 Mbps” as the lower limit value of the rate limiting adjustable range, and temporarily defines the rate limiting adjustable range as “1.2 Mbps or more”. Then, if it is determined, by the processing unit 11, through the first execution of the rate limiting value adjustment procedure, that the designated rate limiting value of “6.9 Mbps” can improve the transmission quality of the target end user device 5′ as well, the processing unit 11 replaces “1.2 Mbps” (which is smaller) with “6.9 Mbps” (which is larger) as the lower limit value of the rate limiting adjustable range, and updates the rate limiting adjustable range from “1.2 Mbps or more” to “6.9 Mbps or more” (i.e., raising the lower limit value of the rate limiting adjustable range). If it is determined, by the processing unit 11, through the second execution of the rate limiting value adjustment procedure, that another designated rate limiting value of “13.8 Mbps” cannot improve the transmission quality of the target end user device 5′, the processing unit 11 sets “13.8 Mbps” as the upper limit value of the rate limiting adjustable range, and updates the rate limiting adjustable range from “6.9 Mbps or more” to “6.9 Mbps to 13.8 Mbps”. If it is determined, by the processing unit 11, through the third execution of the rate limiting value adjustment procedure, that yet another designated rate limiting value of “10.35 Mbps” can improve the transmission quality of the target end user device 5′, the processing unit 11 replaces “6.9 Mbps” (which is smaller) with “10.35 Mbps” (which is larger) as the lower limit value of the rate limiting adjustable range, and updates the rate limiting adjustable range from “6.9 Mbps to 13.8 Mbps” to “10.35 Mbps to 13.8 Mbps”. In contrast, if the designated rate limiting value of “10.35 Mbps” is unable to improve the transmission quality of the target end user device 5′, the processing unit 11 replaces “13.8 Mbps” (which is larger) with “10.35 Mbps” (which is smaller) as the upper limit value of the rate limiting adjustable range (i.e., lowering the upper limit value of the rate limiting adjustable range), and updates the rate limiting adjustable range from “6.9 Mbps to 13.8 Mbps” to “6.9 Mbps to 10.35 Mbps”.

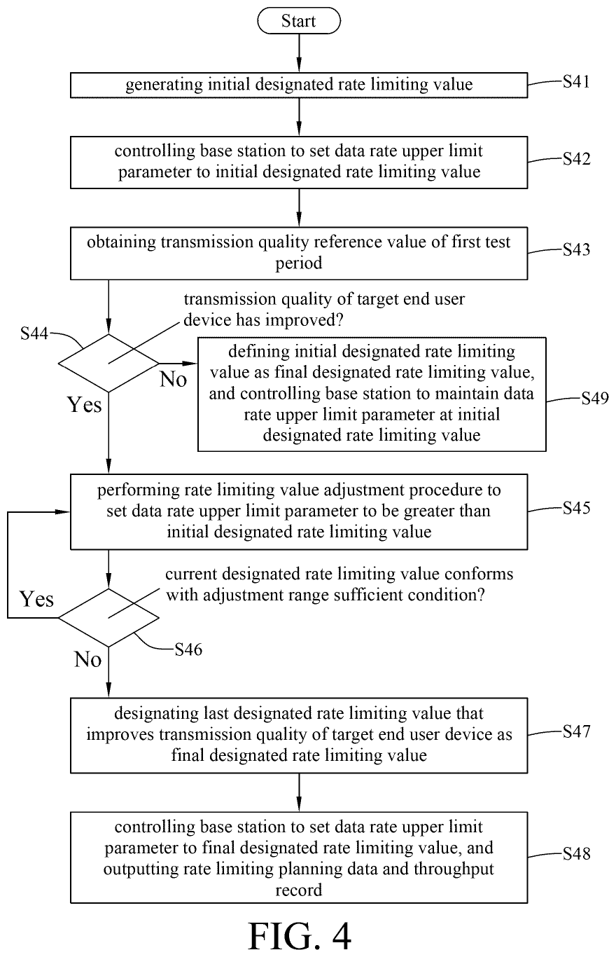

The processing unit 11 repeatedly executes sub-steps S45 and S46 (as shown in FIG. 4) for multiple times to perform the rate limiting value adjustment procedure on the target end user device 5′. Furthermore, the manner of adjusting the rate limiting value and defining the rate limiting adjustable range in sub-step S45, executed by the processing unit 11, varies with the number of times sub-step S45 is executed. Therefore, details of the processing unit 11 executing the rate limiting value adjustment procedure for the first time and the second time will be described in detail in the following.

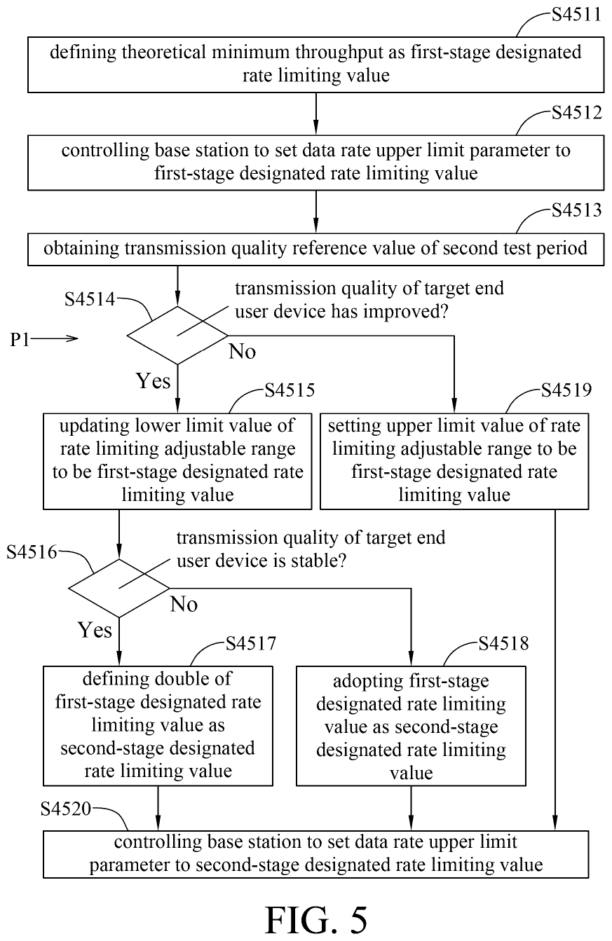

Referring further to FIG. 5, the processing unit 11 executes the rate limiting value adjustment procedure on the target end user device 5′ for the first time as follows.

In sub-step S4511, the processing unit 11 identifies the matching MCS range (for example, “16≥MCS>9” in Table 1) from among the MCS ranges in the rate limiting value mapping table that covers the MCS average value (referring to sub-step S32, for example, 9.2) during the evaluation period, and defines the theoretical minimum throughput (for example, “6.9 Mbps” in Table 1) that corresponds to the matching MCS range as a first-stage designated rate limiting value.

In sub-step S4512, the processing unit 11 controls the base station 2 through the 5G core network to set the data rate upper limit parameter that corresponds to the target end user device 5′ to be the first-stage designated rate limiting value, so as to limit the maximum uplink transmission rate of the target end user device 5′ to be less than or equal to the first-stage designated rate limiting value.

In sub-step S4513, the processing unit 11 obtains the transmission record R of the target end user device 5′ from the log dataset D22 of the base station 2, and reads the transmission quality reference value that corresponds to a second test period. The second test period is another period occurring after the first test period and after the maximum uplink transmission rate of the target end user device 5′ is limited to below the first-stage designated rate limiting value.

In sub-step S4514, the processing unit 11 uses the improvement condition to determine, based on the MCS record R1, the PHR record R2 and the signal quality record R5 of the corresponding transmission record R, whether the transmission quality of the target end user device 5′ during the observed historical period (referring to the second test period) has improved compared to the transmission quality of the target end user device 5′ during the evaluation period.

When the processing unit 11 determines that the transmission quality of the target end user device 5′ has been improved, the rate-limiting procedure proceeds to sub-step S4515. Otherwise, when the processing unit 11 determines that the transmission quality of the target end user device 5′ has not been improved, the rate-limiting procedure proceeds to sub-step S4519.

In sub-step S4519, the processing unit 11 sets the upper limit value of the rate limiting adjustable range to be the first-stage designated rate limiting value, thereby adjusting the rate limiting adjustable range. Then, the processing unit 11 further defines a midpoint value of the rate limiting adjustable range as a second-stage designated rate limiting value. For example, if the rate limiting adjustable range is “1.2 Mbps to 6.9 Mbps”, the processing unit 11 defines the second-stage designated rate limiting value as “4.05 Mbps”, which is equal to an average value of the lower limit value “1.2 Mbps” and the upper limit value “6.9 Mbps”.

In sub-step S4515, the processing unit 11 updates the lower limit value of the rate limiting adjustable range to be the first-stage designated rate limiting value (i.e., raising the lower limit value), thereby adjusting the rate limiting adjustable range, for example, from “1.2 Mbps or more” to “6.9 Mbps or more”. Then, the rate-limiting procedure proceeds to sub-step S4516.

In sub-step S4516, the processing unit 11 determines whether the transmission quality of the target end user device 5′ is stable during the second test period. When the processing unit 11 determines that the transmission quality of the target end user device 5′ is stable, then in sub-step S4517, the processing unit 11 defines a value that is greater than the first-stage designated rate limiting value (e.g., twice of 6.9 Mbps, which is 13.8 Mbps) as a next-stage (i.e., the second-stage) designated rate limiting value.

When the processing unit 11 determines that the transmission quality of the target end user device 5′ is unstable, then in sub-step S4518, the processing unit 11 directly uses the first-stage designated rate limiting value as the second-stage designated rate limiting value (for example, the aforementioned 6.9 Mbps).

Specifically, in sub-step S4516, the processing unit 11 determines whether the transmission quality of the target end user device 5′ is stable during the second test period by determining, based on the MCS record R1 of the corresponding transmission record R, whether the transmission quality of the target end user device 5′ within the observed historical period (referring to the second test period) compared to the transmission quality of the target end user device 5′ within the evaluation period conforms with a stability condition. When the processing unit 11 determines that the stability condition is met, the processing unit 11 determines that the transmission quality of the target end user device 5′ is stable; otherwise, the processing unit 11 determines that the transmission quality of the target end user device 5′ is unstable.

In this embodiment, the stability condition includes a first stability sub-condition and a second stability sub-condition. Only when both the first and second stability sub-conditions are met, will the processing unit 11 determine that the stability condition is met. The first stability sub-condition is that the MCS average value corresponding to the observed historical period is greater than the MCS average value corresponding to the evaluation period, and a difference between those two MCS average values is greater than the MCS improvement threshold value of 4. In other embodiments, the first stability sub-condition may be met as long as the MCS average value corresponding to the observed historical period is greater than the MCS average value corresponding to the evaluation period. The second stability sub-condition is that, for the observed historical period, a difference between a maximum MCS index and a minimum MCS index in the cluster of MCS indexes is less than an MCS fluctuation threshold value (e.g., 2, but the disclosure is not limited to such).

For example, if the maximum MCS index in the cluster of MCS indexes corresponding to the second test period is 21, and the minimum MCS index in the cluster of MCS indexes corresponding to the second test period is 18, then the difference between those two MCS indexes is equal to 3, which is not less than the MCS fluctuation threshold value of 2. In such a case, the processing unit 11 determines, in sub-step S4516, that the second stability sub-condition is not met, and thus the stability condition is not met.

After determining the second-stage designated rate limiting value through sub-steps S4517, S4518 or S4519, in sub-step S4520, the processing unit 11 controls the base station 2, through the 5G core network, to set the data rate upper limit parameter that corresponds to the target end user device 5′ to be the second-stage designated rate limiting value.

After sub-step S4520 is completed, the rate-limiting procedure proceeds to sub-step S46 (as shown in FIG. 4).

In sub-step S46, the processing unit 11 determines whether a current designated rate limiting value that corresponds to the target end user device 5′ conforms with an adjustment range sufficient condition based on the rate limiting adjustable range. When it is determined that the current designated rate limiting value conforms with the adjustment range sufficient condition, the rate-limiting procedure returns to sub-step S45 to re-execute the rate limiting value adjustment procedure for the target end user device 5′.

The adjustment range sufficient condition is that a difference between the current designated rate limiting value and the midpoint value of the rate limiting adjustable range is greater than or equal to a preset adjustment threshold value, or that there is currently no upper limit value (which means there is no midpoint value) for the rate limiting adjustable range. In this embodiment, the preset adjustment threshold value is the smallest theoretical minimum throughput (e.g., 1.2 Mbps) in the rate limiting value mapping table, which is equal to the initial designated rate limiting value and is related to the total number of the end user devices 5, but the disclosure is not limited to such.

In this embodiment, the adjustment range sufficient condition is used to ensure that each adjustment of the designated rate limiting value is greater than or equal to the preset adjustment threshold value, so as to ensure the efficiency of executing the rate-limiting procedure. In one example (different from the previously mentioned example), assuming that the current designated rate limiting value is “13.8 Mbps” and the midpoint value of the rate limiting adjustable range is “20.7 Mbps” (thus the difference therebetween is 6.9 Mbps), if the midpoint value of the rate limiting adjustable range is defined as the next-stage designated rate limiting value, the adjustment of the designated rate limiting value will be “6.9 Mbps”, which is greater than the preset adjustment threshold value (e.g., 1.2 Mbps). In such a case, the processing unit 11 determines that the designated rate limiting value conforms with the adjustment range sufficient condition, and the rate-limiting procedure returns to sub-step S45 to perform the rate limiting value adjustment procedure. On the other hand, in another example, assuming that the designated rate limiting value is “21.7 Mbps” and the midpoint value of the rate limiting adjustable range is “20.7 Mbps” (thus the difference therebetween is 1 Mbps), if the midpoint value of the rate limiting adjustable range is defined as the next-stage designated rate limiting value, the adjustment of the designated rate limiting value will be “1 Mbps”, which is less than the preset adjustment threshold value (e.g., 1.2 Mbps). In such a case, the processing unit 11 determines that the designated rate limiting value does not conform with the adjustment range sufficient condition, and thus no adjustment is made, and the rate-limiting procedure proceeds to sub-step S47.

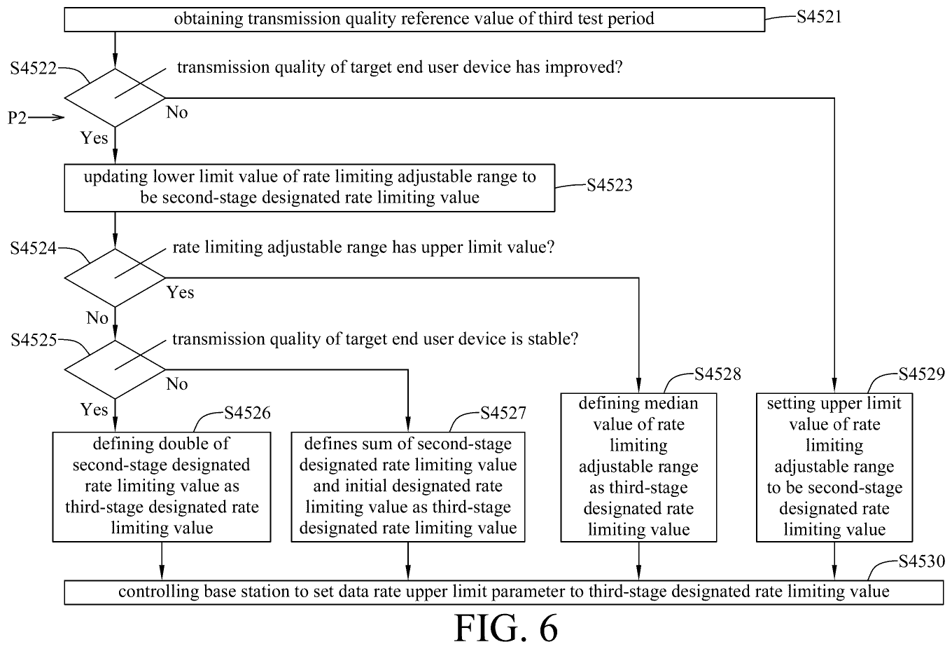

Referring further to FIG. 6, when the rate-limiting procedure returns from sub-step S46 to sub-step S45, the processing unit 11 performs the rate limiting value adjustment procedure on the target end user device 5′ for the second time. For simplicity, it is assumed in this case that the second-stage designated rate limiting value is 13.8 Mbps (i.e., it is assumed that, in sub-step S4516, the processing unit 11 determines that the transmission quality of the target end user device 5′ is stable).

In sub-step S4521, the processing unit 11 obtains the transmission record R of the target end user device 5′ from the log dataset D22 of the base station 2, and reads the transmission quality reference value that corresponds to a third test period. The third test period is yet another period occurring after the second test period and after the data rate upper limit parameter of the target end user device 5′ is set to the second-stage designated rate limiting value.

In sub-step S4522, the processing unit 11 uses the improvement condition to determine, based on the MCS record R1, the PHR record R2 and the signal quality record R5 of the corresponding transmission record R, whether the transmission quality of the target end user device 5′ during the observed historical period (referring to the third test period) has improved compared to the transmission quality of the target end user device 5′ during the evaluation period.

When the processing unit 11 determines, in sub-step S4522, that the transmission quality has not been improved, then in sub-step S4529, the processing unit 11 sets the upper limit value of the rate limiting adjustable range to be the second-stage designated rate limiting value, thereby adjusting the rate limiting adjustable range. Then, the processing unit 11 defines the midpoint value of the rate limiting adjustable range as the third-stage designated rate limiting value. In one example, if the rate limiting adjustable range is defined as “1.2 Mbps to 13.8 Mbps”, the processing unit 11 defines the third-stage designated rate limiting value as “7.5 Mbps”, which is equal to the average value of the lower limit value “1.2 Mbps” and the upper limit value “13.8 Mbps”.

When the processing unit 11 determines that the transmission quality of the target end user device 5′ has been improved, in sub-step S4523, the processing unit 11 updates the lower limit value of the rate limiting adjustable range to be the second-stage designated rate limiting value (i.e., raising the lower limit value), thereby adjusting the rate limiting adjustable range, for example, from “6.9 Mbps or more” to “13.8 Mbps or more”.

In step S4524, the processing unit 11 determines whether the rate limiting adjustable range has an upper limit value.

When the processing unit 11 determines, in sub-step S4524, that the rate limiting adjustable range has the upper limit value, then in sub-step S4528, the processing unit 11 defines the midpoint value of the rate limiting adjustable range as the third-stage designated rate limiting value.

When the processing unit 11 determines that the rate limiting adjustable range does not have the upper limit value, in sub-step S4525, the processing unit 11 further determines whether the transmission quality of the target end user device 5′ is stable during the observed historical period based on the stability condition. When the processing unit 11 determines that the transmission quality of the target end user device 5′ is stable, then in sub-step S4526, the processing unit 11 defines a value that is greater than the second-stage designated rate limiting value (e.g., twice of 13.8 Mbps, which is 27.6 Mbps) as the next-stage (i.e., the third-stage) designated rate limiting value.

When the processing unit 11 determines, in sub-step S4525, that the transmission quality of the target end user device 5′ is unstable, then in sub-step S4527, the processing unit 11 defines a sum of the second-stage designated rate limiting value and the initial designated rate limiting value (e.g., 15 Mbps, which is the sum of 13.8 Mbps and 1.2 Mbps) as the third-stage designated rate limiting value. It should be noted that the third-stage designated rate limiting value defined by the processing unit 11 when it is determined that the transmission quality is stable would be greater than the third-stage designated rate limiting value defined when it is determined that the transmission quality is unstable, thereby ensuring the efficiency for seeking a suitable designated rate limiting value for the target end user device 5′.

After determining the third-stage designated rate limiting value through sub-steps S4526, S4527, S4528 or S4529, in sub-step S4530, the processing unit 11 controls the base station 2, through the 5G core network, to set the data rate upper limit parameter that corresponds to the target end user device 5′ to be the third-stage designated rate limiting value.

After sub-step S4530 is completed, sub-step S46 (as shown in FIG. 4) is performed again. Specifically, if the determination result of sub-step S46 is again “yes”, and thus sub-step S45 is performed again, the processing unit 11 performs the rate limiting value adjustment procedure for the target end user device 5′ for the third time and thereafter in a manner similar to the second execution.

In sub-step S47, when the processing unit 11 determines that the current designated rate limiting value does not conform with the adjustment range sufficient condition, the processing unit 11 designates the last (i.e., most recently set) designated rate limiting value that improves the transmission quality of the target end user device 5′ as the final designated rate limiting value.

In sub-step S48, after designating the final designated rate limiting value that corresponds to the target end user device 5′, the processing unit 11 controls the base station 2, through the 5G core network, to set the data rate upper limit parameter that corresponds to the target end user device 5′ to be the final designated rate limiting value. Additionally, the processing unit 11 further generates rate limiting planning data that includes the final designated rate limiting value, obtains a throughput record from the base station 2, and outputs the rate limiting planning data and the throughput record. The throughput record indicates the total throughput of data transmission of the base station 2 with the end user devices 5 after setting, for each of the target end user devices 5′, the data rate upper limit parameter to be the corresponding final designated rate limiting value. The processing unit 11 may output the rate limiting planning data and the throughput record by storing them in the storage medium 12, transmitting them to a management terminal computer (not shown), or displaying them through a display device (not shown).

When the processing unit 11 determines, in sub-step S44, that the transmission quality of the target end user device 5′ has not improved, it means that even limiting the maximum transmission rate of the target end user device 5′ does not help improve its transmission quality, thus sub-step S49 is performed. In such a case, the processing unit 11 defines the initial designated rate limiting value (e.g., 1.2 Mbps) as the final designated rate limiting value, and controls the base station 2 to maintain the data rate upper limit parameter that corresponds to the target end user device 5′ at the initial designated rate limiting value, thereby ensuring that the target end user device 5′ occupies only a relatively minimal amount of network resources.

Referring back to FIGS. 1 and 2, in step S5, the processing unit 11 performs a signal variation observation procedure for all of the end user devices 5. By executing the signal variation observation procedure, the processing unit 11 determines, based on the variation of the transmission quality of each end user device 5, whether to remove the restriction on the maximum transmission rate of one or more of the target end user devices 5′, or to define one or more other end user devices 5 that were not originally designated as the target end user devices 5′ as new target end user devices 5′ to restrict their maximum transmission rate.

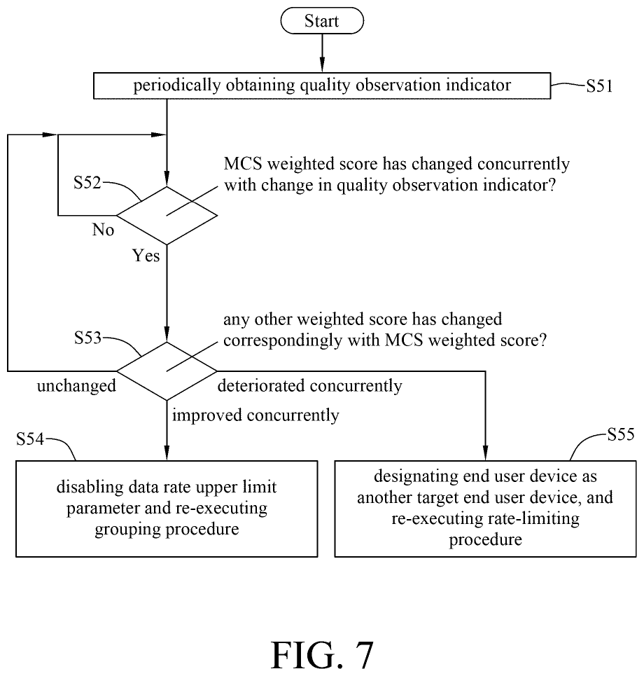

Referring further to FIG. 7, the signal variation observation procedure includes sub-steps S51 to S55. In the following description, the signal variation observation procedure for only one of the end user devices 5 is described in detail for the sake of brevity.

In sub-step S51, for the end user device 5, the processing unit 11 periodically (e.g., for every historical period) calculates a plurality of weighted scores respectively based on the transmission quality reference values of the corresponding transmission record R, and sums up the weighted scores to obtain a quality observation indicator that corresponds to the end user device 5 for that historical period. The weighted scores include the aforementioned MCS weighted score, the PHR weighted score, the MIMO layer weighted score, the BLER weighted score, and the signal quality weighted score. Each quality observation indicator is substantially the same as the aforementioned quality assessment indicator, and will not be repeated here.

In sub-step S52, the processing unit 11 determines whether the transmission quality of the end user device 5 has changed based on the quality observation indicators corresponding to two consecutive historical periods and a preset variation threshold (e.g., 3, but not limited to such). The processing unit 11 further determines whether the MCS weighted score of the end user device 5 has changed concurrently with the change in the quality observation indicators during the two consecutive historical periods.

Specifically, when the processing unit 11 determines that a difference between the two quality observation indicators corresponding respectively to the two consecutive historical periods is greater than the preset variation threshold, the processing unit 11 determines that the transmission quality of the end user device 5 has changed.

Table 2 shows an example of the quality observation indicators of the end user device 5 in five consecutive historical periods starting from the timestamp “10:45”. For example, as shown in Table 2, a first quality observation indicator that corresponds to the timestamp “10:55” is equal to “12”, and a second quality observation indicator that corresponds to the timestamp “11:00” is equal to “5”. The difference between the two quality observation indicators is equal to “7”, which is greater than the preset variation threshold of 3. Therefore, the processing unit 11 determines that the transmission quality of the end user device 5 has changed based on the first quality observation indicator and the second quality observation indicator.

TABLE 2

| Time stamp | 10:45 | 10:50 | 10:55 | 11:00 | 11:05 |
|---|---|---|---|---|---|
| Quality | 14 | 12 | 12 | 5 | 6 |
| observation | | | | | |
| indicator | | | | | |

The processing unit 11 then compares a first MCS weighted score that is used to calculate the first quality observation indicator with a second MCS weighted score that is used to calculate the second quality observation indicator. When the processing unit 11 determines that the first MCS weighted score and the second MCS weighted score are not equal to each other, the processing unit 11 determines that the MCS weighted score of the end user device 5 has changed concurrently with the change in the quality observation indicator, and the signal variation observation procedure proceeds to sub-step S53. Otherwise, when the processing unit 11 determines that the first MCS weighted score and the second MCS weighted score are equal to each other, the processing unit 11 determines that the MCS weighted score of the end user device 5 has not changed concurrently with the change in the quality observation indicator, and the signal variation observation procedure returns to sub-step S52 to make the determination for the subsequent historical period.

In sub-step S53, the processing unit 11 determines whether any other weighted score (i.e., the PHR weighted score, the MIMO layer weighted score, the BLER weighted score and the signal quality weighted score) of the two consecutive historical periods has changed (improves or deteriorates) correspondingly with the MCS weighted score (e.g., the MIMO layer weighted score and the MCS weighted score both increase or both decrease), or whether all other weighted scores remain unchanged. When the processing unit 11 determines that any other weighted score has improved concurrently, the signal variation observation procedure proceeds to sub-step S54. When the processing unit 11 determines that any other weighted score has deteriorated concurrently, the signal variation observation procedure proceeds to sub-step S55. When the processing unit 11 determines that all other weighted scores remain unchanged, the signal variation observation procedure returns to sub-step S52 to make the determination for the subsequent historical period.

In sub-step S54, when the end user device 5 is one of the target end user devices 5′, the processing unit 11 disables the data rate upper limit parameter that corresponds to the end user device 5 and re-executes the grouping procedure (i.e., the process returns to step S1 of FIG. 2). The processing unit 11 disables the data rate upper limit parameter by, for example, controlling the base station 2, through the 5G core network, to set the data rate upper limit parameter to be a theoretically unreachable high transmission rate, or to be a disable code that causes the base station 2 to stop limiting the transmission rate of the end user device 5 based on the data rate upper limit parameter. It is noted that in the case that the end user device 5 is not one of the target end user devices 5′, the process still returns to step S1.

In sub-step S55, the processing unit 11 designates the end user device 5 as another target end user device 5′, and re-executes the rate-limiting procedure (i.e., starting from step S4 of FIG. 2) for the another target end user device 5′ to determine its corresponding designated rate limiting value. It is noted that in the case that the end user device 5 is originally one of the target end user devices 5′, the process still returns to step S4. In addition, if one of the other weighted scores improves concurrently with the MCS weighted score while another one of the other weighted scores deteriorates concurrently with the MCS weighted score, the procedure is designated to proceed to sub-step S55. Nevertheless, the disclosure is not limited to such.

Table 3 below shows an implementation result of this embodiment, where the total uplink bandwidth is evenly distributed among the end user devices 5. Overall, this embodiment increases the total uplink throughput of the five end user devices 5 (where the ones marked with “*” are the target end user devices 5′) by approximately 46.7%.

TABLE 3

| | Uplink throughput when the | |
|---|---|---|
| End user | total uplink bandwidth is | Uplink throughput of this |
| device | evenly distributed (Mbps) | embodiment (Mbps) |
| A* | 3.2 | 1.2 |
| B | 47.4 | 74.5 |
| C* | 3 | 2.2 |
| D | 49.4 | 77.3 |
| E* | 7.4 | 6.8 |
| Total uplink | 110.4 | 162 |
| throughput | | |

According to another embodiment of the disclosure, a computer program product is adapted to be executed to manage network resources. The computer program product includes an application program that is stored in a computer-readable storage medium, and when the application is loaded and executed by a computer device (e.g., a server device including a processor and a data storage device), the application program enables the computer device to implement the aforementioned method for network resource management, such that the computer device is used as the management system 1.

In summary, by implementing the method for managing network resources, the management system 1 defines those of the end user devices 5 that have relatively poor transmission quality to be the target end user devices 5′ based on the quality assessment indicators, and generates a corresponding designated rate limiting value for each target end user device 5′. The management system 1 then controls the base station 2 to set the data rate upper limit parameter of each target end user device 5′ to be the corresponding designated rate limiting value, thereby limiting the maximum transmission rate between each target end user device 5′ and the base station 2. As a result, the management system 1 is able to reduce the network resources occupied by those of the end user device(s) 5 with poor transmission quality, allowing the base station 2 to utilize the bandwidth resources more effectively and increasing the total throughput of the base station 2.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements. 10

What is claimed is:

1. A method for network resource management, implemented by a management system, adapted to manage network resources that are needed for data transmission between a base station and a plurality of end user devices, the base station storing a network resource management dataset and a log dataset, the network resource management dataset including a plurality of data rate upper limit parameters, each of which corresponds to a respective one of the end user devices and is used for limiting a maximum rate for transmission between that end user device and the base station, the log dataset including a plurality of transmission records, each of which corresponds to a respective one of the end user devices and indicates a variation in transmission quality of that end user device, the method comprising steps of:
A) calculating, based on the plurality of transmission records, a plurality of quality assessment indicators that correspond respectively to the end user devices, wherein each of the plurality of quality assessment indicators indicates the transmission quality of the corresponding one of the end user devices within an evaluation period;
B) ranking the end user devices based on the quality assessment indicators, and designating at least one of the end user devices having the lowest rank as at least one target end user device;
C) for each of the target end user devices, obtaining a designated rate limiting value that corresponds to the target end user devices based on the corresponding transmission record; and
D) controlling the base station to set, for each of the target end user devices, the corresponding data rate upper limit parameter to be the designated rate limiting value that corresponds to the target end user device.

2. The method as claimed in claim 1, each of the transmission records including an average power headroom report (PHR) that indicates a spare state of a transmission power of the corresponding one of the end user devices during the evaluation period,
wherein, in step B), the management system designates, based on the average PHRs of the end user devices, the at least one of the end user device having the lowest rank which has the spare state of the transmission power being insufficient as the at least one target end user device.

3. The method as claimed in claim 1, each of the transmission records including a plurality of transmission quality reference values that correspond to the evaluation period,
wherein, in step A), for each of the quality assessment indicators, the management system calculates a weighted sum of the transmission quality reference values that correspond to the evaluation period to obtain a value of the quality assessment indicator.

4. The method as claimed in claim 1, wherein in step C), the management system generates, based on a preset worst signal condition, an initial designated rate limiting value for each of the at least one target end user devices; and
wherein in step D), the management system controls the base station to set the data rate upper limit parameters corresponding respectively to the at least one target end user devices to be the initial designated rate limiting value;
the method further comprising steps of, after step D), for each of the at least one target end user devices:
E) determining whether the transmission quality of the target end user device has improved based on the corresponding transmission record;
F) in response to determining that the transmission quality of the target end user device has improved, performing a rate limiting value adjustment procedure on the target end user device to set the corresponding data rate upper limit parameter to be greater than the initial designated rate limiting value; and
G) in response to determining that the transmission quality of the target end user device has not improved, defining the initial designated rate limiting value as a final designated rate limiting value, and maintaining the data rate upper limit parameter of the target end user device at the initial designated rate limiting value.

5. The method as claimed in claim 4, the network resource management dataset further including a resource block (RB) total quantity parameter and uplink-downlink configuration data, the RB total quantity parameter indicating a total number of RBs provided by the base station, and the uplink-downlink configuration data indicating a ratio of an uplink bandwidth portion to a downlink bandwidth portion in a total bandwidth provided by the base station;
wherein in step C), the management system determines the initial designated rate limiting value by first obtaining a theoretical total throughput based on the RB total quantity parameter and a simulation parameter set, and then obtaining the initial designated rate limiting value based on the theoretical total throughput, the uplink-downlink configuration data, and a total number of the end user devices;
wherein the simulation parameter set indicates a plurality of transmission settings that are set by the base station for each of the end user devices under a default worst signal condition, where the initial designated rate limiting value is a minimum bandwidth that is able to be allocated by the base station to each of the end user devices based on the simulation parameter set.

6. The method as claimed in claim 4, each of the transmission records including a Modulation and Coding Scheme (MCS) record which has a plurality of clusters of MCS indexes corresponding to a plurality of periods, wherein in step E), the management system determines whether the transmission quality of the target end user device has improved by determining, based on the MCS record of the corresponding transmission record, whether the transmission quality of the target end user device during a historical period, as compared with the transmission quality of the target end user device during the evaluation period, satisfies an improvement condition.

7. The method as claimed in claim 6, wherein the improvement condition includes a difference between an MCS average value corresponding to the historical period and another MCS average value corresponding to the evaluation period being greater than an MCS improvement threshold value, and
wherein for each of the plurality of clusters of MCS indexes, the MCS average value of the cluster is an average value of the MCS indexes of the cluster.

8. The method as claimed in claim 4, wherein in step F), the management system further defines a rate limiting adjustable range that corresponds to the target end user device by: designating, as a lower limit value of the rate limiting adjustable range, the maximum designated rate limiting value that improves the transmission quality of the target end user device; and designating, as an upper limit value of the rate limiting adjustable range, the minimum designated rate limiting value that does not improve the transmission quality of the target end user device.

9. The method as claimed in claim 8, further comprising, after step F), steps of:
H) determining whether a current designated rate limiting value conforms with an adjustment range sufficient condition;
I1) in response to determining that the current designated rate limiting value conforms with the adjustment range sufficient condition, returning to step F), where the adjustment range sufficient condition includes a difference between the current designated rate limiting value and a midpoint value of the rate limiting adjustable range being greater than or equal to a preset adjustment threshold value;
I2) in response to determining that the current designated rate limiting value does not conform with the adjustment range sufficient condition, designating, as the final designated rate limiting value, the last designated rate limiting value that improves the transmission quality of the target end user device; and
J) after designating the final designated rate limiting value corresponding to each of the target end user devices, setting the data rate upper limit parameter for each of the target end user device to be the final designated rate limiting value.

10. The method as claimed in claim 9, wherein in step F), the preset adjustment threshold value is equal to the initial designated rate limiting value.

11. The method as claimed in claim 9, the management system storing a rate limiting value mapping table which includes a plurality of MCS ranges and a plurality of theoretical minimum throughputs respectively corresponding to the plurality of MCS ranges, each of the transmission records including an MCS record which has a plurality of clusters of MCS indexes corresponding to a plurality of periods; wherein in step F), the management system performs the rate limiting value adjustment procedure on the target end user device for a first time based on the rate limiting value mapping table.

12. The method as claimed in claim 11, wherein the management system performs the rate limiting value adjustment procedure on the target end user device for the first time by:
identifying a matching MCS range among the plurality of MCS ranges in the rate limiting value mapping table that covers the MCS average value, and defining the theoretical minimum throughput that corresponds to the matching MCS range as a first-stage designated rate limiting value;
setting the data rate upper limit parameter of the target end user device to be the first-stage designated rate limiting value;
determining whether the transmission quality of the target end user device is stable;
in response to determining that the transmission quality of the target end user device is stable, defining a value that is greater than the first-stage designated rate limiting value as a second-stage designated rate limiting value;
in response to determining that the transmission quality of the rate limiting target end user device is not stable, defining the first-stage designated rate limiting value as the second-stage designated rate limiting value; and
setting the data rate upper limit parameter of the target end user device to be the second-stage designated rate limiting value.

13. The method as claimed in claim 12, wherein in response to determining that the transmission quality of the target end user device is stable, the management system defines a value that is double the first-stage designated rate limiting value as the second-stage designated rate limiting value.

14. The method as claimed in claim 12, wherein in step F), the management system determines whether the transmission quality of the target end user device is stable by determining, based on the MCS record of the corresponding transmission record, whether the transmission quality of the target end user device during a historical period compared to the transmission quality of the target end user device during the evaluation period conforms with a stability condition.

15. The method as claimed in claim 14, wherein in step F), the management system obtains an MCS average value corresponding to the historical period and another MCS average value corresponding to the evaluation period based on the MCS record,
wherein the stability condition includes the MCS average value corresponding to the historical period being greater than the another MCS average value corresponding to the evaluation period, and a difference between a maximum one of the plurality of MCS indexes corresponding to the historical period and a minimum one of the plurality of MCS indexes corresponding to the historical period is less than an MCS fluctuation threshold value.

16. The method as claimed in claim 15, wherein in step F), the management system performs the rate limiting value adjustment procedure on the target end user device for a second time by:
based on the MCS record of the corresponding transmission record, determining whether the transmission quality of the target end user device during another historical period has improved compared to the transmission quality of the target end user device during the evaluation period;
in response to determining that the transmission quality has been improved, updating the lower limit value of the rate limiting adjustable range to be the second-stage designated rate limiting value, and determining whether the rate limiting adjustable range has the upper limit value;
in response to determining that the rate limiting adjustable range does not have the upper limit value, determining whether the transmission quality of the target end user device is stable;
in response to determining that the transmission quality of the target end user device is stable, defining a value that is greater than the second-stage designated rate limiting value as a third-stage designated rate limiting value;
in response to determining that the transmission quality of the target end user device is not stable, defining a sum of the second-stage designated rate limiting value and the initial designated rate limiting value as the third-stage designated rate limiting value;
in response to determining that the rate limiting adjustable range has the upper limit value, defining the midpoint value of the rate limiting adjustable range as the third-stage designated rate limiting value;
in response to determining that the transmission quality has not improved, updating the upper limit value of the rate limiting adjustable range to be the second-stage designated rate limiting value, and defining the midpoint value of the rate limiting adjustable range as the third-stage designated rate limiting value; and
setting the data rate upper limit parameter that corresponds to the target end user device to be the third-stage designated rate limiting value.

17. The method as claimed in claim 7, each of the transmission records including a plurality of transmission quality reference values, the method further comprising, after step J), steps of, for each of the end user devices:
K) obtaining a plurality of quality observation indicators for a plurality of periods by periodically calculating a plurality of weighted scores respectively based on the transmission quality reference values of the corresponding transmission record and summing the plurality of weighted scores;
L) determining whether the transmission quality of the end user device and an MCS weighted score among the plurality of weighted scores have both changed concurrently, wherein determining whether the transmission quality has changed is based on the quality observation indicators of the end user device and a preset variation threshold;
M) in response to determining that the transmission quality of the end user device and the MCS weighted score have both changed concurrently, further determining whether any other weighted score has changed correspondingly with the MCS weighted score, such that both increase or both decrease;
N) in response to determining that the any other weighted score has changed correspondingly with the MCS weighted score, further determining whether the any other weighted score improves or deteriorates correspondingly with the MCS weighted score;
O) in response to determining that the any other weighted score improves correspondingly with the MCS weighted score, when the end user device is one of the target end user device, disabling the data rate upper limit parameter that corresponds to the end user device; and
P) in response to determining that the any other weighted score deteriorates correspondingly with the MCS weighted score, designating the end user device as another target end user device, and performing step C) for the new target end user device.

18. A management system for managing network resources that are needed for data transmission between a base station and a plurality of end user devices, the base station storing a network resource management dataset and a log dataset, the network resource management dataset including a plurality of data rate upper limit parameters, each of which corresponds to a respective one of the end user devices and is used for limiting a maximum rate for transmission between that end user device and the base station, the log dataset including a plurality of transmission records, each of which corresponds to a respective one of the end user devices and indicates a variation in transmission quality of that end user device, the management system comprising:
a storage medium storing instructions; and
a processing unit electrically connected to said storage medium, wherein said processing unit is configured to execute the instructions stored in said storage medium to perform the method as claimed in claim 1.

19. A computer program product adapted to be executed to manage network resources that are needed for data transmission between a base station and a plurality of end user devices, the base station storing a network resource management dataset and a log dataset, the network resource management dataset including a plurality of data rate upper limit parameters, each of which corresponds to a respective one of the end user devices and is used for limiting a maximum rate for transmission between that end user device and the base station, the log dataset including a plurality of transmission records, each of which corresponds to a respective one of the end user devices and indicates a variation in transmission quality of that end user device, the computer program product comprising:
an application program, wherein, when the application is loaded and executed by a computer device, the application program enables the computer device to perform the method as claimed in claim 1.
